(19) United States
(12) Patent Application Publication
(10) Pub. No.: US 2011/0278146 A1
(43) Pub. Date: Nov. 17, 2011

(54) KEY SWITCH AND ELECTRONIC DEVICE

(75) Inventors: Yong Zheng, Beijing (CN); Tetsuo Matsumura, Kanagawa (JP); Kazuaki Takamori, Kanagawa (JP)

(73) Assignee: PANASONIC CORPORATION, Osaka (JP)

(21) Appl. No.: 12/864,486

(22) PCT Filed: Jan. 24, 2008
(86) PCT No.: PCT/CN2008/000182

§ 371 Date: Oct. 12, 2010

(51) Int. Cl. H01H 13/76

(52) U.S. Cl. 200/5 A

(57) ABSTRACT

Key switches and an electronic device are provided, which have excellent design in which the key tops cover at least the whole of the width direction and the sides. A key switch (100) has a flat key top (110) in which adjacent key are disposed with no space therebetween, and portions of the key top (110) corresponding to keys located at the left and right ends of the key switch (100) each has a curved surface R as an end part (100a) of the key switch (100), which wraps around a side of a case and fits into a groove part (220a) of an outer frame (220). The key switch (100) includes the key top (110), a metal frame (120), and an elastic plate member supporting substrate (130), and a backside of the key top (110) is bonded to surfaces of elastic plate members (132, 133) of the elastic plate member supporting substrate (130) by silicon adhesive. The metal frame (120) is sandwiched between the key top (110) and the elastic plate member supporting substrate (130).

### TECHNICAL FIELD

The present invention relates to key switches for key operation of mobile telephones and mobile information terminals, and an electronic device with the key switches.

### BACKGROUND ART

Mobile terminals such as mobile telephones generally have a printed circuit board inside the casing and have electronic elements mounted on this printed circuit board. These mobile terminals utilize key switches to output command signals outside by bringing the contacts provided on the printed circuit board into contact by pressing keys. With an increase in the number of functions, the number of operation keys also tends to increase and importance is also placed on design.

Many key switches have a structure in which push buttons (key tops) for performing input operations by pressing, are exposed from the operation openings formed in the casing of an electronic device. For example, a key sheet providing key tops is placed on a substrate where contact switches are disposed, and is covered with a casing from the front side of the key sheet, thereby incorporating a key sheet in a casing.

Patent Document 1 describes a key sheet having a pressing operating section; a base sheet made of a rubber-like elastic material, which is placed on a circuit board upon which electronic components are provided; and a thermal diffusion member that accelerates diffusion of heat generated from the electronic components, in the plane direction of the base sheet.

Patent Document 2 describes an operating member including button members with a key top and a key stem; a device casing having opening parts from which the key tops are exposed; a sheet member made of an elastic material having key stem opening parts through which the key stems penetrate, holding by pressing the button members in the button opening parts; and a substrate upon which a switch is provided that forms a signal transmission path when the key top is pressed and the switch is pressed by the key stem.

FIG. 1 is a cross-sectional view of a main part of a mobile telephone having conventional key switches.

In FIG. 1, key switch 1 is comprised of contacts 13 provided on printed circuit board 12 inside body case of the mobile telephone; diaphragm 14 provided immediately above contacts 13; and key sheet 15 displaceably supported between body case 11 of the mobile telephone and printed circuit board 12. Key sheet 15 includes base sheet 16 made of a rubber-like elastic material; and a plurality of key tops 17 formed on the surface of the operating side. Key tops 17 are formed by coating, plating, inscription, or ion-plating the surface of key sheet 15. Alternatively, key tops 17 may be made of a different resin than base sheet 16, which is made of a rubber-like elastic material.

In key switch 1, a switching operation (diaphragm 15 is brought into contact/conduction with a contact) is performed by the pressing force that acts on key top 17. Thus, on a backside of key sheet 15 facing printed circuit board 12, a pusher member 18 is formed in a cylindrical shape for each key top 17. Pusher members 18 are each a portion that presses contact 13 of diaphragm 14 on printed circuit board 12. In addition, a leg part is provided in a projecting manner on the entire perimeter of key sheet 15 and between adjacent key tops 17, and the tips of respective leg parts 19 abut on diaphragm 14 of printed circuit board 12.

The entire perimeter of the surface of key sheet 15 receives pressure by a holding section 11a projecting from an inner surface of body case 11 of the mobile telephone. In addition, body case 11 of the mobile telephone has operation opening 11b formed therein for each key top 17 and each operation opening 11b is formed partitioned by partition 11c. Key tops 17 are integrally formed with key sheet 15 and have a flange structure in which a bottom portion extends with respect to operation opening 11b of body case 11 of the mobile telephone. By the flange structure, key tops 17 are slidably supported by respective operation openings 11b and are prevented from dropping off from the front side of body case 11.

In this configuration, in key switch 1, when desired key top 17 is pressed, key sheet 15 is bent with pressed key top 17 in the center and corresponding pusher member 18 in the back of key sheet 15 is pressed in and comes into contact with diaphragm 14 attached to printed circuit board 12, pressing diaphragm 14. As a result, diaphragm 14 comes into contact with corresponding contact 13 and contact 13 is brought into conduction, and, by this means, the switch performs switching operations.
Patent Document 1: Japanese Patent Application Laid-Open No. 2007-134310
Patent Document 2: Japanese Patent Application Laid-Open No. 2006-244823

### DISCLOSURE OF INVENTION

### Problems to be Solved by the Invention

However, with such conventional key switches, the configuration is such that key tops of a flange structure are accommodated in respective operation openings in the body case, and there is a problem that the form and arrangement of key tops are limited.

For example, as shown in FIG. 1, in key switch 1 of a mobile telephone, key tops 17 having a flange structure are disposed in respective operation openings 11b of body case 11. While the flange structure prevents key tops 17 from falling, the flange structure limits the form and arrangement of key tops 17, resulting in a so-called button switch in which key tops 17 are provided in respective operation openings 11b in body case 11 at locations spaced apart from each other at regular intervals. Specifically, as a key operating section of a mobile telephone, key switch 1 cannot help but has a form of an ordinary key operating section, in which push buttons are arranged vertically and horizontally at regular intervals. Since the form and arrangement of key tops are limited, the appearance of design of the device on which key switches are mounted, is also limited, making the design uniform. At present, as an important element for product distinction, there is a tendency to place more importance on design but conventional key switches do not adequately meet such a demand.

The present invention is made in view of such a problem and it is therefore an object of the present invention to provide key switches and an electronic device that are excellent in design in which a key top covers at least the entire surface in the width direction and sides.

### Means for Solving the Problem

A key switch of the present invention adopts a configuration in which the key switch includes: a key top in which a plurality of keys are arranged; an elastic plate member supporting substrate that has first elastic plate members projecting so as to face the keys in the key top, and pusher members that push a diaphragm at back of the first elastic plate members; a frame that is sandwiched between the key top and the elastic plate member supporting substrate and holds a form of the key top; and a printed circuit board that has contacts that are brought into conduction by pressing the diaphragm, and, in this configuration: keys located at an end of the key top have a form in which the keys have a curved surface as an end part of the key top, which wraps around a side; a backside of the key top is bonded to surfaces of the first elastic plate members; and the frame includes an engaging part that engages with a structure including the printed circuit board.

An electronic device of the present invention includes a key switch in a casing and adopts a configuration including the key switch.

### ADVANTAGEOUS EFFECT OF THE INVENTION

According to the present invention, it is possible to implement key switches and an electronic device that can prevent the keys at the end part of key tops from falling and that are excellent in design allowing the key tops to cover at least the entire surface in the width direction and sides.

### BRIEF DESCRIPTION OF DRAWINGS

FIG. 1 is a cross-sectional view of a main part of a mobile telephone including conventional key switches;

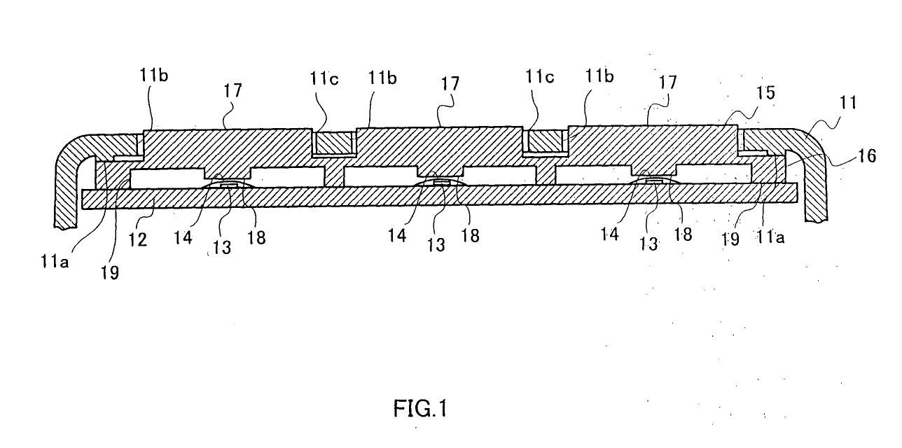

FIG. 2 is a perspective view showing a schematic configuration of an electronic device including key switches according to one embodiment of the present invention;

FIG. 3 is a perspective view showing a schematic configuration of the electronic device from which the key switch according to the embodiment is removed;

FIG. 4 is a cross-sectional view taken along line A-A of FIG. 2;

FIG. 5 is an exploded perspective view showing a structure of the key switch according to the embodiment;

FIG. 6 is a top view of the key switch according to the embodiment;

FIG. 7 is a backside view of the key switch according to the embodiment;

FIG. 8 is a top view showing an elastic plate member supporting substrate of the key switch according to the embodiment; and

FIG. 9 is a cross-sectional view taken along line A-A of FIG. 6.

### BEST MODE FOR CARRYING OUT THE INVENTION

An embodiment of the present invention will be described in detail below with reference to the drawings.

### Embodiment

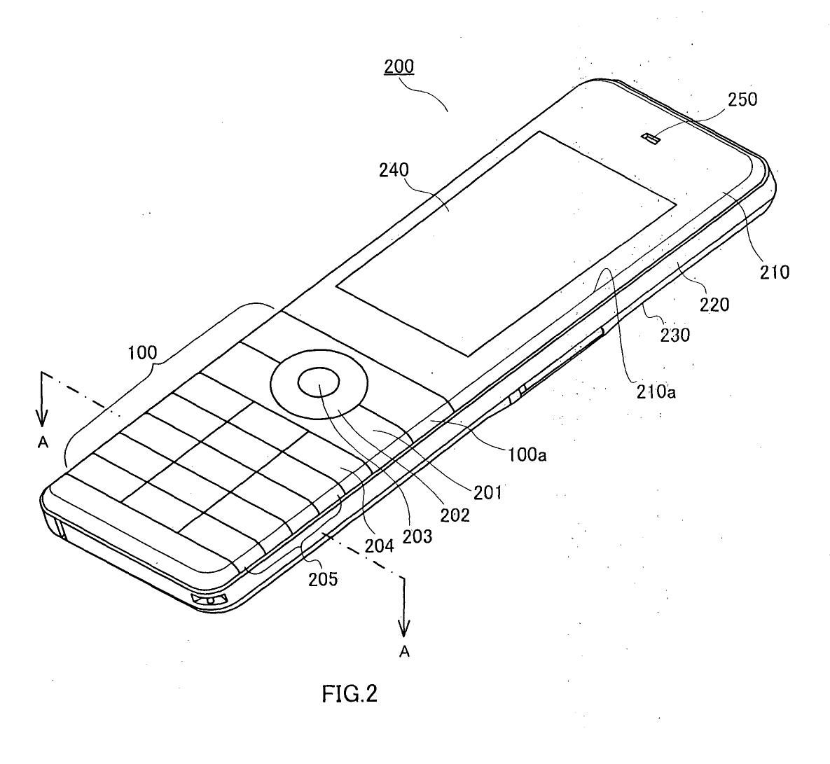

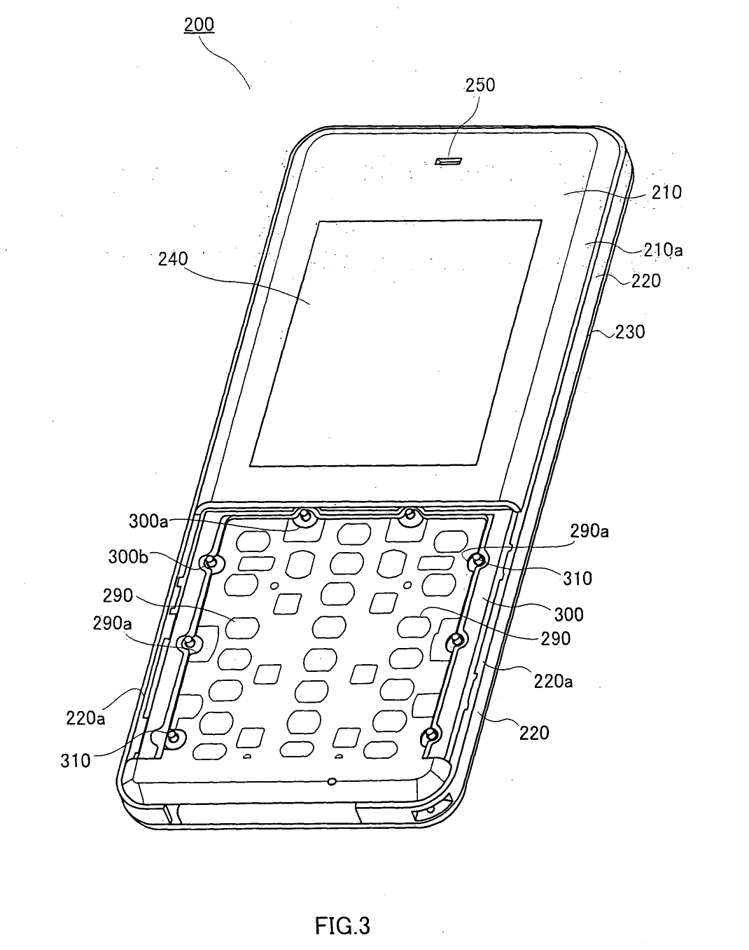

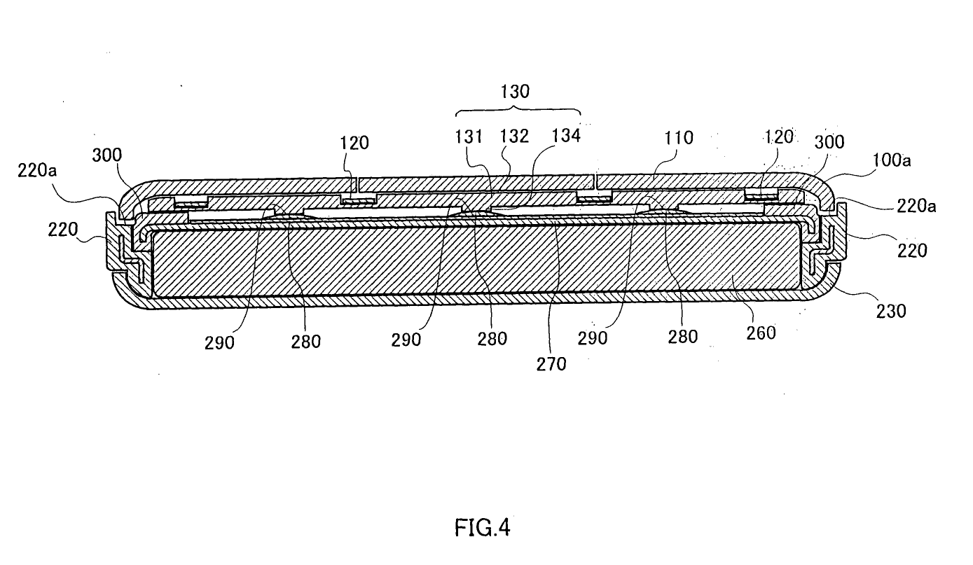

FIG. 2 is a perspective view showing a schematic configuration of an electronic device including key switches according to one embodiment of the present invention. FIG. 3 is a perspective view showing a schematic configuration of the electronic device from which the key switch is removed. FIG. 4 is a cross-sectional view taken along line A-A of FIG. 2.

The present embodiment is an example in which a key switch and an electronic device are applied to a portable communication terminal of a mobile telephone/PHS (Personal Handy-Phone System). The key switches and electronic device may be applied to a mobile information terminal such as a PDA (Personal Digital Assistants).

In FIG's. 2 to 4, mobile terminal 200 according to the present embodiment is made of upper casing 210 having end part 210a with a curved surface R; key switch 100 that serves as a key operating section and that forms the same plane as a surface of upper casing 210 and has end parts 100a with the same curved surface R as end part 210a of upper casing 210; outer frame 220 having groove part 220a (FIG. 4) in which the entire perimeter part of each of end part 210a of upper casing 210 and end parts 100a of key switch 100 fits; and lower casing 230 that supports outer frame 220 from below.

Upper casing 210, outer frame 220, and lower casing 230 each are made of a resin molded product which is an insulating material, e.g., a non-conductive ABS resin.

Outer frame 220 is attached to lower casing 230, and the whole forms a lower body case. Note that outer frame 220 and lower casing 230 may be formed in one piece.

Since upper casing 210 and key switch 100 respectively have end parts 210a and 100a having the same curved surface R and the surface of upper casing 210 and a key top surface of key switch 100 have the same plane, when upper casing 210 and key switch 100 are attached into groove part 220a of lower casing 220, upper casing 210 and key switch 100 form a case body having an integral surface appearance.

Key switch 100 has flat key top 110 in which adjacent keys are disposed with no space therebetween, and portions of key top 110 corresponding to keys located at the left and right ends of key switch 100 have a form in which the portions each have a curved surface R as end part 100a of key switch 100, which wraps around groove part 220a of outer frame 220. Since outer frame 220 is a thin structure, even when the perimeter parts of end parts 100a of key switch 100 fit into groove part 220a, it does not give the appearance that the perimeter parts of end parts 100a of key switch 100 fit in groove part 220a. Therefore, key switch 100 has a novel external appearance that portions of key top 110 corresponding to keys located at the left and right ends extend toward the outside of the case and compose part of the case body, which has not been found in the conventional example. As such, key switch 100 does not have a key top in which push buttons are exposed every predetermined spacing, which is customary for conventional mobile terminals, but has a configuration with a delicate curved surface in which a key top is formed such that portions of key top 110 corresponding to keys located at the left and right ends wrap around both end parts of a case body.

Key switch 100 of the present embodiment is characterized in the form and structure of the key switch and thus an assignment of a key function to a key is not limited. Mobile terminal 200 including key switch 100 may be any electronic device. Using FIG. 2, an example of mobile terminal 200 and an assignment of keys of key switch 100 will be described.

In FIG. 2, mobile terminal 200 includes the key switch 100 that serves as an operating section and that has operation key buttons; an LCD display section 240 that color displays reception information and information such as an image and guidance for an operation; and loudspeaker 250 for receiving a call. Mobile terminal 200 includes therein circuit section 260 (FIG. 4) such as a radio circuit, a control circuit, and an information processing circuit. Note that, though not shown, in lower casing 220 are provided a speaker that outputs a ring-tone and the like, a camera section that shoots an image, a connector section that connects mobile terminal 200 to an external device, and the like.

In terms of the functions of mobile terminal 200, to key switch 100 are assigned mode keys 201 for switching between various functions; cursor key 202 that causes a selected object to move in an up, down, left, or right direction; determination key 203 that performs an operation determination and the like; telephone function keys 204 for switching between an incoming call, an outgoing call, and a telephone function; and numeric keys 205 for inputting a telephone number, characters, and the like. Cursor key 202 is a circular cross key, and has determination key 203 disposed at the center thereof and has two rectangular mode keys 201 in a column and two rectangular mode keys 201 in a row formed therearound. In addition, below rectangular telephone function keys 204 disposed in a row, there are four rectangular numeric keys 205 in a column and three rectangular numeric keys 205 in a row formed in a matrix. In the case of FIG. 2, among the respective keys including mode keys 201, determination key 203, telephone function keys 204, and numeric keys 205, portions of key top 110 corresponding to keys located at the left and right ends extend toward sides of the case and form the lower part of the case body surface.

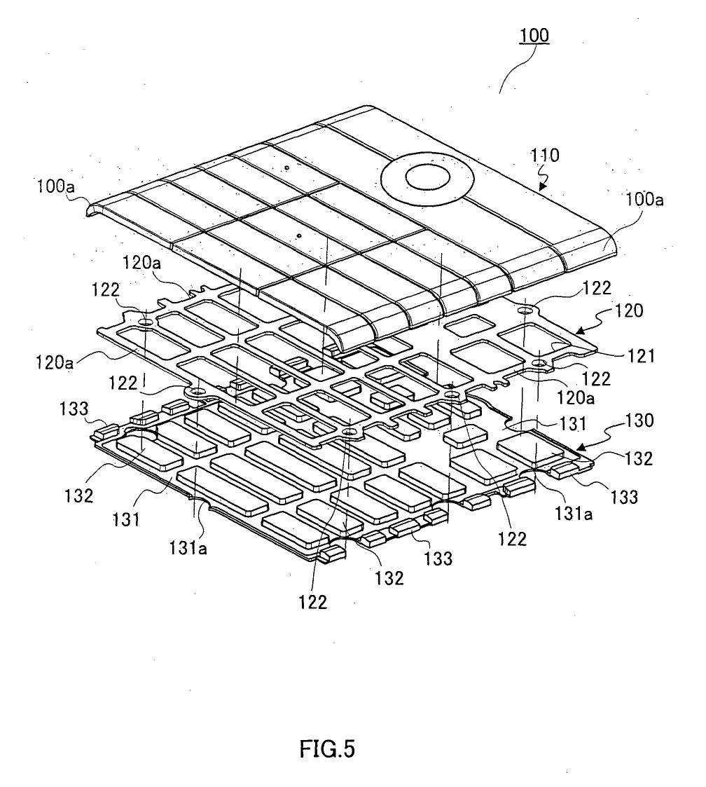

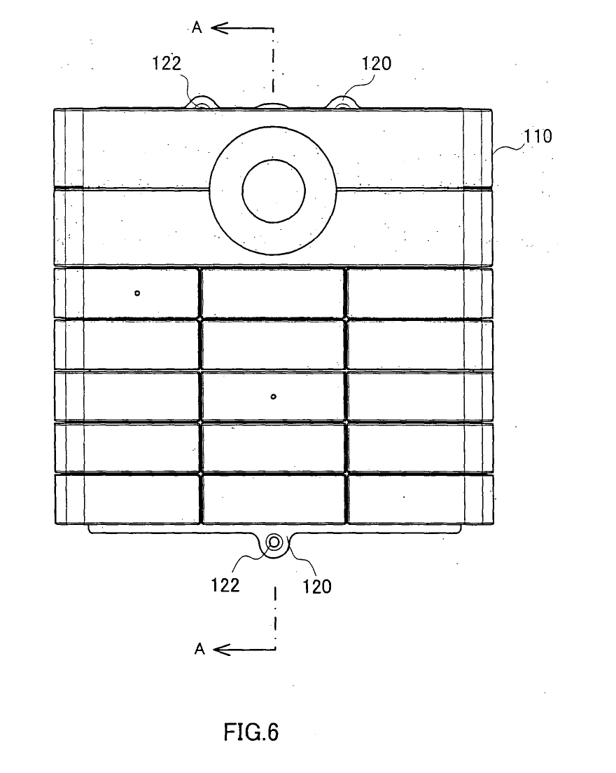

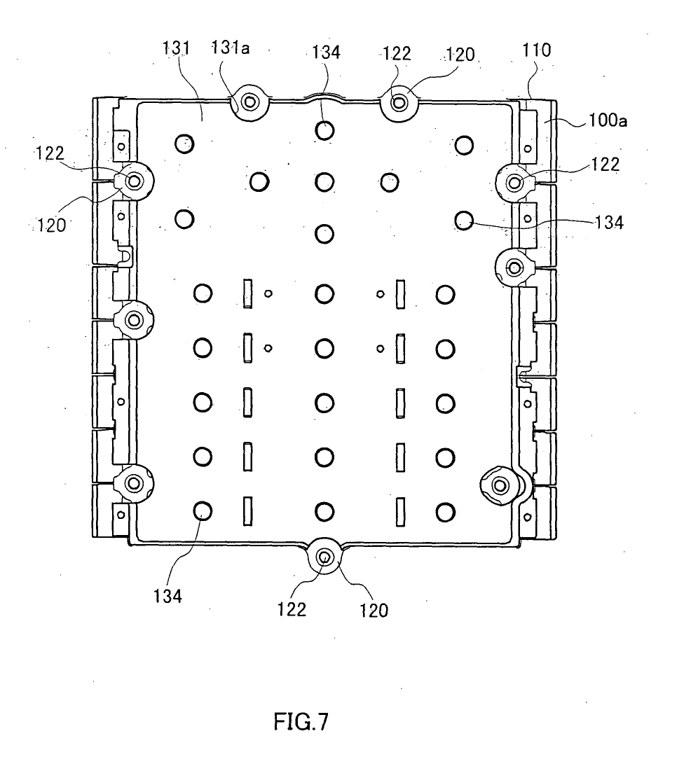

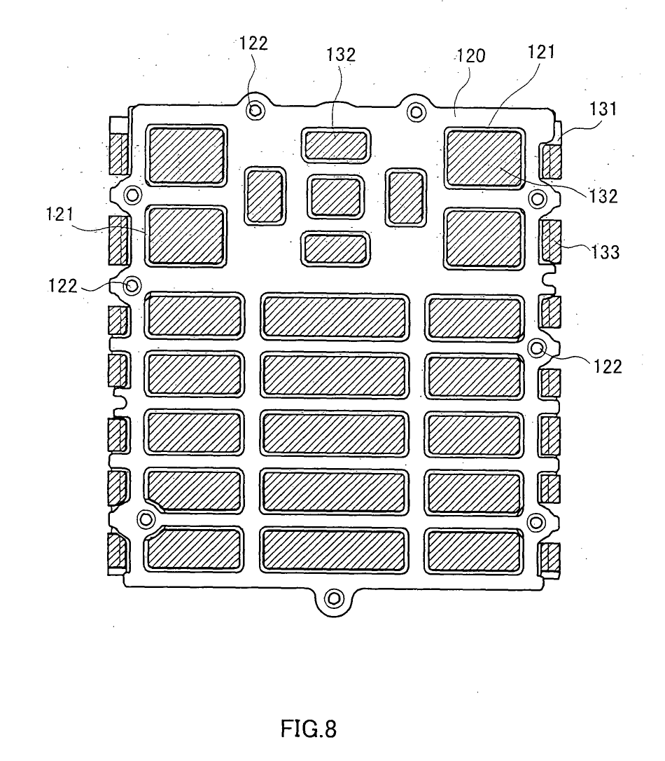

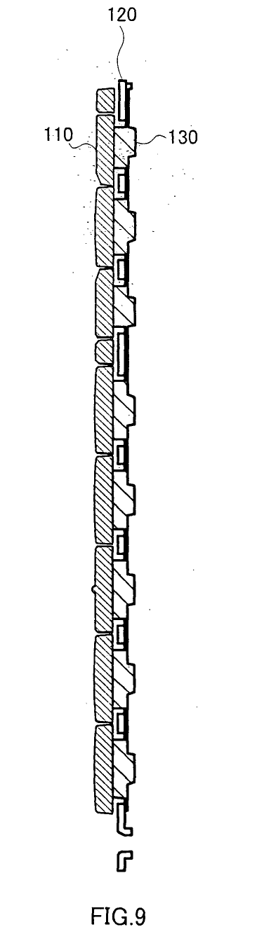

FIG. 5 is an exploded perspective view showing a structure of key switch 100. FIG. 6 is a top view of key switch 100, FIG. 7 is a backside view of key switch 100, and FIG. 8 is a top view showing an elastic plate member supporting substrate of key switch 100. FIG. 9 is a cross-sectional view taken along line A-A of FIG. 6.

In FIG's. 5 and 9, key switch 100 is made of key top 110 of a keypad structure, metal frame 120, and elastic plate member supporting substrate 130.

Key top 110 has keys 201 to 205 arranged therein in a matrix. On the front side of key top 110, symbols, characters, numeric values, and the like, that correspond to these keys 201 to 205 are formed by coating, plating, inscription, or ion-plating. In addition, to the back of key top 110 are firmly bonded surfaces of elastic plate members 132 (described later) of elastic plate member supporting substrate 130 by a silicon adhesive, at locations corresponding to respective keys 201 to 205.

Metal frame 120 is a middle frame which supports the form of key switch 100 by stiffness and which is made of stainless steel, for example. Metal frame 120 has substantially the same dimension and form as key top 110 and elastic plate member supporting substrate 130, and includes screw holes 121 that allow elastic plate members 132 of elastic plate member supporting substrate 130 to communicate therethrough; and a plurality of screw holes 122 for screwing lower casing 220. Metal frame 120 has perimeter frame 120a formed along an perimeter surface of key top 110 so as to protect at least end parts 100a of key switch 100. Screw holes 122 are opened at predetermined locations of this perimeter frame 120a. Screw holes 122 are opened in portions of perimeter frame 120a located between vertically adjacent keys at end parts 100a of key switch 100. By the opening locations of screw holes 122, when metal frame 120 is screwed to lower casing 220 and the elastic plate member supporting substrate 130 is between the metal frame 120 and the lower casing, unsteadiness of keys at end parts of key top 110 is prevented, helping to prevent the keys at the end parts of key top 110 from falling. Metal frame 120 has perimeter frame 120a and screw holes 122 opened in the predetermined locations of perimeter frame 120a. The form of inner frame crosspieces within perimeter frame 120a is arbitrary. In view of weight reduction, a reduction in the number of the inner frame crosspieces is also considered. However, according to a mounting test conducted by the present inventors, it has been found that a structure of the present embodiment in which inner frame crosspieces correspond to respective keys 201 to 205 of key top 110 and have substantially the same form as elastic plate members 132 of elastic plate member supporting substrate 130 provides good balance upon pressing keys, leading to an improvement in operability.

Elastic plate member supporting substrate 130 is aflexible substrate made of a silicon rubber, and includes a base sheet 131 made of a rubber-like elastic material; rectangular elastic plate members 132 that face, on the front side of base sheet 131, respective keys 201 to 205 of key top 110 and correspond to the forms of respective keys 201 to 205 and that project toward respective keys 201 to 205; strip-shaped elastic plate members 133 that face, on the front side of base sheet 131, the outermost of keys located at the left and right ends of key top 110 and project toward end parts at the left and right ends of key top 110; and cylindrical pusher members 134 (see FIG. 7) that receive, in the back of base sheet 131, pressure from respective keys 201 to 205 of key top 110.

Elastic plate members 132 and 133 are disposed on the front side of base sheet 131 so as to face respective keys 201 to 205 of key top 110 and end parts of key top 110, and pusher members 134 are disposed in the back of base sheet 131 so as to be abut on diaphragm 290 which will be described later. Base sheet 131 has recesses 131a that avoid screws 310 which are engaged in screw holes 122 of perimeter frame 120a of metal frame 120.

The aforementioned key switch 100 is incorporated in outer frame 220 and lower casing 230, together with upper casing 210, as a key operating section of mobile terminal 200.

Again, in FIGS. 3 and 4, in lower casing 230 and outer frame 220 of mobile terminal 200 is accommodated circuit section 260 such as a radio circuit, and on printed circuit board 270 of circuit section 260 are placed contacts 280; diaphragm 290 provided immediately above contacts 280; and positioning member 300 disposed to surround diaphragm 290 and fixing diaphragm 290 by holding a perimeter of diaphragm 290. The printed circuit board 270, contacts 280, and diaphragm 290 compose, as a whole, membrane keys. Diaphragm 290 has recesses 290a having the same form as recesses 131a of base sheet 131, to avoid screws 310 that are engaged in screw holes 122 of perimeter frame 120a of metal frame 120. In addition, positioning member 300 has communicating holes 300a that allow the aforementioned screws 310 to communicate therethrough; and recesses 300b.

Referring back to FIG. 5, in key switch 100, a silicon adhesive (not shown) is applied to surfaces of elastic plate members 132 and 133 of elastic plate member supporting substrate 130, whereby the surfaces of elastic plate members 132 and 133 of elastic plate member supporting substrate 130 are firmly bonded to the back of key top 110 via the silicon adhesive. Here, since the surface forms of elastic plate members 132 are relatively large rectangular forms in agreement with the forms of respective keys 201 to 205 of key top 110, elastic plate members 132 have a large bonding area and thus can obtain a strong bonding force. In addition, the outermost of keys located at the left and right ends of key top 110 is further bonded by means of strip-shaped elastic plate members 133 of elastic plate member supporting substrate 130, whereby keys at end parts of key top 110 are strongly prevented from falling.

Furthermore, elastic plate members 132 for the keys located at the left and right ends of key top 110 and elastic plate members 133 provided outside such elastic plate members 132 are bonded to the back of key top 110 with perimeter frame 120a of metal frame 120 being sandwiched therebetween. Namely, by bonding the surfaces of elastic plate members 132 and 133 to the backside at end parts of key top 110 at both ends of perimeter frame 120a with perimeter frame 120a of metal frame 120 being sandwiched therebetween, elastic plate members 133 in particular are supported without being bent due to the stiffness of perimeter frame 120a adjacent thereto and since there is no such bending, the bond strength of elastic plate members 133 is maintained over the years. For these reasons, the end parts of key top 110 are more strongly protected.

The structure of key switch 100 itself protects the keys at the end parts of key top 110. Specifically, upon assembling, as shown in FIG. 5, in key switch 100, key top 110, metal frame 120, and elastic plate member supporting substrate 130 are overlaid with one another, a silicon adhesive is applied to surfaces of elastic plate members 132 and 133 of elastic plate member supporting substrate 130, and they are communicated through screw holes 121 of metal frame 120. Then, the surfaces of elastic plate members 132 and 133 of elastic plate member supporting substrate 130 having the silicon adhesive applied thereto are bonded to the back of key top 110.

By this means, in key switch 100, while the backsides of the respective keys 201 to 205 of key top 110 are bonded to the surfaces of elastic plate members 132 and 133 of elastic plate member supporting substrate 130, metal frame 120 sandwiched between key top 110 and elastic plate member supporting substrate 130 is just sandwiched between these key top 110 and elastic plate member supporting substrate 130 and is not coupled and has flexibility that allows metal frame 120 to move a little within a range of space between elastic plate members 132 and 133 and screw holes 121. In this state, screws 310 are allowed to communicate through screw holes 121 of metal frame 120 from lower casing 220 below diaphragm 290 and positioning member 300, whereby metal frame 120 is engaged with lower casing 220 by screws 310 with diaphragm 290, positioning member 300, and elastic plate member supporting substrate 130 being sandwiched therebetween. By the engagement of metal frame 120 with lower casing 220, key top 110 and elastic plate member supporting substrate 130 that sandwich metal frame 120 are attached to lower casing 220. At this time, the perimeter parts of end parts 100a of key switch 100 are attached so as to fit in groove part 220a of outer frame 220. In key switch 100, by screwing metal frame 120 to lower casing 220 by screws 310, the entire key top 110 and elastic plate member supporting substrate 130 which sandwich metal frame 120 are fixed to mobile terminal 200 as key switch 100.

When key switch 100 is attached to mobile terminal 200, a pressing force that acts on any key 201 to 205 of key top 110 is transferred to a corresponding elastic plate member 132 of elastic plate member supporting substrate 130 and base sheet 131 integrally formed with elastic plate members 132 is bent at the location of the pressed key. In the back of base sheet 131 facing printed circuit board 270, pusher member 134 is formed in a cylindrical shape for each of keys 201 to 205 of key top 110. When a portion of base sheet 131 corresponding to a pressed key location is bent, pusher member 134 at such a location comes into contact with diaphragm 290 of printed circuit board 270, pressing diaphragm 290. Asa result, diaphragm 290 comes into contact with contact 280 and contact 280 is brought into conduction, whereby the switch performs a switching operation.

The moving stroke of pressing of respective keys 201 to 205 of key top 110 is 0.1 to 0.2 mm, for example, which is sufficiently small over the length of an arrangement interval for each key. Thus, in the present structure in which metal frame 120 is disposed below key top 110, key top 110 can ensure a good stroke. For the same reason, even when adopting the present structure in which the surfaces of elastic plate members 133 are bonded, at the outside of perimeter frame 120a of metal frame 120, to the backside at the end parts of key top 110, keys on the inner side of perimeter frame 120a can ensure a good stroke.

A summary of technical elements of key switch 100 configured in the above manner will be described below.

(1) Key switch 100 has flat key top 110 in which adjacent keys are disposed with no space therebetween, and portions of key top 110 corresponding to keys located at the left and right ends of key switch 100 each have a curved surface R as end part 100a of key switch 100, which wraps around a side of a case and fits into groove part 220a of thin outer frame 220. Since catching to end parts of key top 110 is eliminated, it is possible to prevent the end parts of key top 110 from falling. A foreign matter or the like gets caught in space between keys and due to this a key top falls off, which is considered to be the biggest damage factor. According to the present embodiment, the outermost edges of end parts 100a of key switch 100 fit into groove part 220a of outer frame 220, whereby catching to end parts is eliminated, making it possible to significantly reduce the possibility of falling off of keys. In addition, since outer frame 220 is thin, a fine appearance is not impaired. Moreover, even when adopting a configuration in which groove part 220a is relatively shallow, since the stiffness of key top 110 is maintained by metal frame 120, end parts 100a never come off groove part 220a due to bending of key top 110 or the like.

(2) Key switch 100 includes key top 110, metal frame 120, and elastic plate member supporting substrate 130, and the back of key top 110 is bonded to surfaces of elastic plate members 132 and 133 of elastic plate member supporting substrate 130 by a silicon adhesive. Metal frame 120 is just sandwiched between key top 110 and elastic plate member supporting substrate 130 and is not fixed. Metal frame 120 is engaged with lower casing 220 by screws 310 with diaphragm 290, positioning member 300, and elastic plate member supporting substrate 130 sandwiched therebetween, by allowing screws 310 to communicate through screw holes 121 provided in perimeter frame 120a of metal frame 120, from lower casing 220 below diaphragm 290 and positioning member 300. By metal frame 120 being engaged with lower casing 220 by screws 310, the entire key switch 100 is attached to lower casing 220.

(3) Metal frame 120 has perimeter frame 120a formed along an perimeter surface of key top 110, and the perimeter frame 120a has a plurality of screw holes 122 opened therein at locations between vertically adjacent keys. By the opening locations of screw holes 122, when metal frame 120 is screwed to lower casing 220, unsteadiness of keys at end parts of key top 110 is prevented, which prevents the keys at the end parts of key top 110 from falling.

(4) Elastic plate member supporting substrate 130 includes a flexible base sheet 131; elastic plate members 132 conforming to the forms of the respective keys 201 to 205 of key top 110, which are provided in a projecting manner on the front side of base sheet 131; and strip-shaped elastic plate members 133 provided in a projecting manner on the front side of base sheet 131 at locations at the left and right ends of key top 110. The back of base sheet 131 has a cylindrical pusher member 134 abutting on diaphragm 290, which is provided in a projecting manner for each of keys 201 to 205. Since the surfaces of elastic plate members 132 have a large area in agreement with the forms of the respective keys 201 to 205 of key top 110, a strong bonding force is obtained due to a large bonding area, thereby preventing key top 110 from falling. In addition, the outermost of keys located at the left and right ends of key top 110 is further bonded by means of strip-shaped elastic plate members 133 of elastic plate member supporting substrate 130, whereby falling off of the keys at the end parts of key top 110 is strongly prevented. Furthermore, by bonding the surfaces of elastic plate members 132 and 133 to the backside at the end parts of key top 110 at both ends of perimeter frame 120a with perimeter frame 120a of metal frame 120 being sandwiched therebetween, bending at the end parts of key top 110 is prevented, making it possible to further prevent the keys at the end parts of key top 110 from falling.

By the above-described (1) to (4), the end parts of key top 110 are strongly protected against an external force, making it possible to prevent key top 110 from easily falling off the side of the device. By this, the form of key switch 100 in which end parts 100a of key switch 100 each have a curved surface R which wraps around a side of the case, becomes implementable for the first time. As shown in FIG. 2, key switch 100 has an outer form having delicate curved surfaces which are integral with upper casing 210 of mobile terminal 200 and having rich design.

In the conventional example, the configuration is such that key tops of a flange structure are accommodated in respective operation openings of a body case, and thus, it is difficult to fabricate a flat key top in which adjacent keys are disposed with no space therebetween. Particularly, at end parts of key top 110, the flange structure is disposed in the case below the key top and the flange structure requires to secure certain space on both sides of the key top, and thus, a configuration in which the end parts of the key top reach the sides of the case is not implemented. In the present embodiment, the form and arrangement of key top 110 have remarkable characteristics that they are not subjected to regulation of the inside of key switch 100, and thus, the form and arrangement of key top 110 have high flexibility and a key switch and a mobile terminal that are excellent in design become implementable for the first time.

The above description is illustrative of a preferred embodiment of the present invention and thus the scope of the present invention is not limited thereto.

Although the embodiment describes an example in which a key switch is applied to a mobile terminal of a mobile telephone, the key switch can be applied not only to a mobile telephone but also to a mobile information terminal such as a PDA, a personal computer or an apparatus combining a personal computer, or a portable device such as an MP3 player or an HDD player.

Although, in the embodiment, names such as a key switch and a mobile terminal are used, this is for convenience of description, and thus, needless to say, a key switch apparatus, a switch structure, a keyboard apparatus, an electronic device, and the like, can also be used.

Furthermore, the type, material, number, connection method, and the like, of the respective parts composing the key switch, e.g., a key top, a middle frame, and an elastic plate member supporting substrate, can be any. Although an engaging part generally uses screwing, the direction and placement location of screwing can be appropriately changed.

### INDUSTRIAL APPLICABILITY

A key switch and an electronic device according to the present invention can provide a key switch and an electronic device that have no crosspieces on their external appearance side, can prevent keys at end parts of a key top from falling, and are excellent in design allowing the key top to cover at least the entire surface. In a width direction and sides. The present invention is useful to apply to a key operating section of a mobile terminal, such as a mobile telephone or PHS, or the like. In addition, a key switch can be incorporated in various electronic devices other than mobile terminals.

1. A key switch comprising:
a key top in which a plurality of keys is arranged;
an elastic plate member supporting substrate that has first elastic plate members projecting so as to face the keys, and pusher members that push diaphragms at back of the first elastic plate members;
a frame that is between the key top and the elastic plate member supporting substrate; and
a circuit board that has contacts that are brought into conduction by pressing the diaphragms, wherein:
the keys located at an end of the key top have a form in which the keys have a curved surface as an end part of the key top, the key top wraps around a side of the key switch;
a backside of the key top is bonded to surfaces of the first elastic plate members;
the frame includes an engaging part that engages with a structure including the circuit board; and
the elastic plate member supporting substrate is between the frame and the structure.

2. The key switch according to claim 1, further comprising a casing having a groove part into which an perimeter part of the end part of the key top fits.

3. The key switch according to claim 1, wherein:
the elastic plate member supporting substrate further includes second elastic plate members projecting so as to face outermost portions of the keys located at the end of the key top; and
a backside at the end of the key top is bonded to surfaces of the second elastic plate members.

4. The key switch according to claim 3, wherein the first elastic plate members and the second elastic plate members are bonded to the back of the key top with an perimeter frame of the frame being between the first elastic plate members and the second elastic plate members.

5. The key switch according to claim 1, wherein the frame comprises:
opening parts through which the respective first elastic plate members communicate with the back of the key top.

6. The key switch according to claim 1, wherein:
the frame has an perimeter frame that protects the end part of the key top; and
the perimeter frame has the engaging part at a predetermined location, according to a key arrangement of the key top.

7. The key switch according to claim 6, wherein:
the engaging part is between adjacent keys.

8. An electronic device comprising a key switch, wherein the key switch is the key switch according to claim 1.
